(19) United States
(12) Patent Application Publication
(10) Pub. No.: US 2012/0228938 A1
(43) Pub. Date: Sep. 13, 2012

(54) DC-AC Inverter Assembly, in Particular Solar Cell Inverter

(75) Inventors: Walter Thieringer, Reutlingen (DE); Gisbert Krauter, Kirchberg (DE); Bernhard Feuchter, Waiblingen (DE); Georg Mayer, Ditzingen (DE); Liliane Gasse, Dettenhausen (DE)

(73) Assignee: Robert Bosch GMBH, Stuttgart (DE)

(21) Appl. No.: 13/395,438

(22) PCT Filed: Jul. 20, 2010
(86) PCT No.: PCT/EP10/60501

§ 371 Date: May 25, 2012

(30) Foreign Application Priority Data
Sep. 11, 2009 (DE) 102009029387.6

(51) Int. Cl. H02M 7/5387; H02J 1/10

(52) U.S. Cl. 307/43; 363/132

(57) ABSTRACT

A DC-AC inverter assembly, in particular a solar cell inverter of a photovoltaic plant, is disclosed. The inverter includes a semiconductor bridge circuit and wherein a DC chopper controller is provided for creating half-waves of an AC voltage on the output side and the bridge circuit is connected downstream of the DC chopper controller and acts as pole changer on the half-waves.

The invention relates to an inverter arrangement according to the precharacterizing clause of claim 1 and of claim 10.

### PRIOR ART

Inverter arrangements such as these have been known for a long time inter alia from control systems for AC and polyphase motors, and from power technology. In the latter field, they have become widely used as direct-current/alternating-current (AC-DC) converters for conversion of a DC voltage produced by photovoltaic installations or fuel cells to an AC voltage for feeding into a power supply system. Converters of this or a similar type are also used when using other recuperative energies, for example in the case of wind power installations, Stirling machines, heat pumps or modern energy storage systems based on primary and/or secondary cells.

A DC-AC inverter arrangement of this generic type is known from DE 10 2004 030 912 B3.

One major aim of the further development of such converters is to achieve a higher efficiency, and further aims may result from the requirements of the operators of supply systems and from corresponding Standards.

### DISCLOSURE OF THE INVENTION

A DC-AC inverter arrangement having the features of claim 1 is proposed. Furthermore, a photovoltaic installation having an inverter arrangement such as this is proposed, and finally an AC-DC inverter arrangement having the features of claim 10. Expedient developments of the inventive concept are the subject matter of the dependent claims. In conventional inverter circuits, a B4 bridge circuit is used in order to produce an AC voltage from DC voltage. This bridge circuit operates at a high switching frequency and thus produces switching losses and on-state losses, which are governed by the choice of components.

The invention describes a possible way in which the half-cycles of the output-side AC voltage are not produced by the bridge, but by an upstream direct-current controller. The bridge now operates only as a polarity changer. Semiconductor components in the bridge can thus be designed for low on-state losses, because the bridge in this case switches only with twice the power supply system frequency (100 times in the case of 50 Hz), and only when the output-side voltage is crossing through zero and therefore, in addition, U(C_TSS or C_HTSS)=0. Negligible switching losses occur in this case.

In particular, this makes it possible to use transistors with a low R_{ds,on} in the bridge circuit for switches S1 in the bridge. This can contribute significantly to reducing the power loss, since these components need be designed only for the peak value of the output voltage and can therefore have a very low R_{ds,on}, even when the converter has a wide input-voltage range. In addition, these transistors can also be switched on via a diode during reverse conductance, with the result that only a minimal voltage drop is produced across the component even in this operation state.

Because the direct-current controller has only two semiconductor components instead of four by comparison with the bridge circuit, the switching nozzles are only half as great as in the generally conventional case, with the electrical characteristics of the circuit otherwise being comparable.

In one embodiment of the invention, the direct-current controller has a buck converter. In further embodiments, the direct-current controller has a combination of a buck converter and a boost converter, or a boost/buck converter with a common inductance.

In a further embodiment, the direct-current controller is in the form of a four-quadrant controller, and therefore with a feedback capability, and the inverter arrangement therefore has a reactive-power capability. Due to the feedback capability, this embodiment makes it possible to provide reactive power to the power supply system, as may possibly be required in the future by electricity works. Furthermore, the feedback capability is also suitable for various other applications. For example, the converter with a feedback capability is also able to produce direct current in a regulated form from alternating current, as a result of which this topology is suitable, for example, for chargers.

In order to achieve the aim mentioned further above of reducing the power loss to as great an extent as possible, in a further embodiment, the components of the semiconductor bridge circuit are chosen to minimize line losses, while secondarily taking account of switching losses. In particular, in this case, the switching devices in the bridge circuit have MOSFETs or IGBTs with a low R_{ds,on} value.

In a manner which is suitable for conventional power supply system configurations, the semiconductor bridge circuit is in the form of an H-bridge for a single-phase output.

### DRAWINGS

Advantages and useful forms of the invention will also become evident from the following description of exemplary embodiments and with reference to the figures, in which:

FIG. 1 shows a circuit diagram of a first embodiment of the invention,

FIG. 2 shows a circuit diagram of a second embodiment of the invention,

FIG. 3 shows a circuit diagram of a third embodiment of the invention,

FIG. 4 shows a circuit diagram of a fourth embodiment of the invention and

FIG. 5 shows an illustration in the form of a graph of the time profile of the output voltage of the overall arrangement, and of the voltage produced by the direct-current controller, for the embodiment shown in FIG. 4.

The following terminology applies to the description of the exemplary embodiments.
TSS: Buck converter, power-electronic basic circuit for voltage conversion, for which U₁>U₂.
HSS: Boost converter, power-electronic basic circuit for voltage conversion, for which U₂>U₁.
HTSS: Boost/buck converter, combination of TSS and HSS with a common inductance, for which U₁ and U₂ may be independent of one another (U₁>=<U₂).

U₁ (referred to as u_1 in the figures) is the input voltage of the circuit, and U₂ (u_2 in the figures) is the output voltage of the circuit.

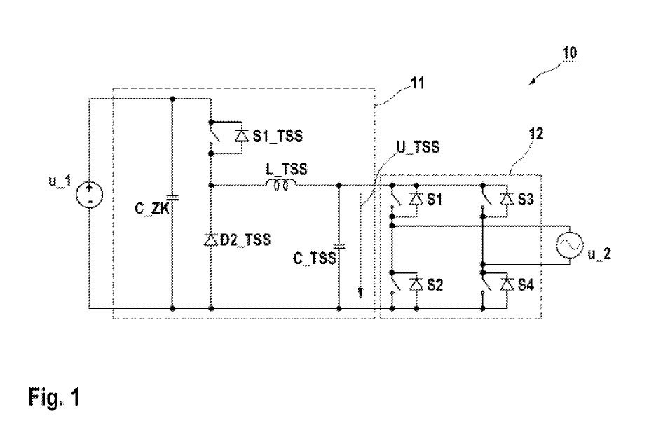

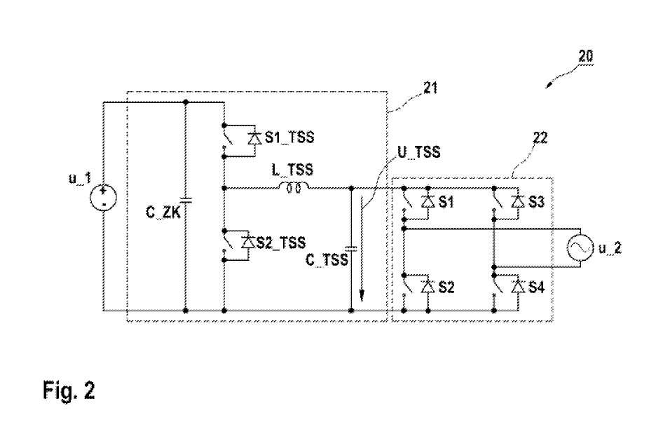

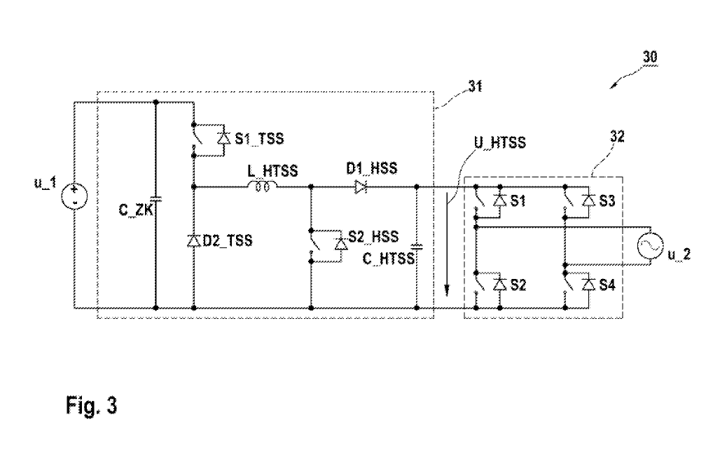

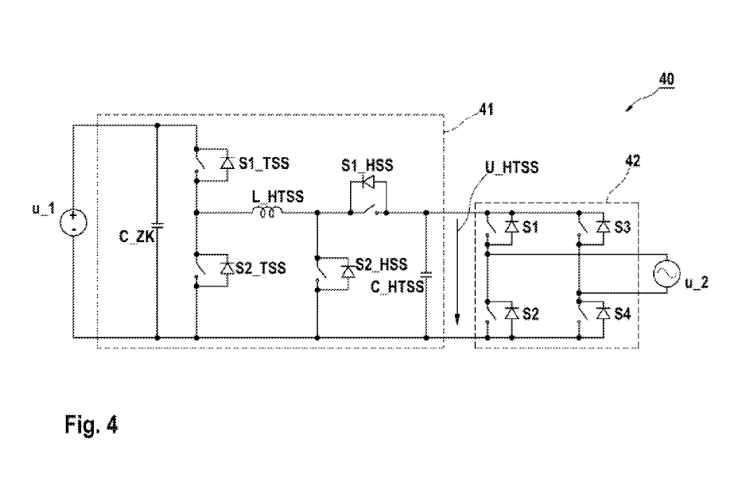

U_{TSS} (referred to as U_TSS in FIGS. 1 and 2) is the voltage at the output of the buck converter, and U_{HTSS} (referred to as U_HTSS in FIGS. 3 and 4) is the voltage at the output of the boost/buck converter.

The circuit diagrams in FIGS. 1 to 4 are essentially self-explanatory, with the result that no complete verbal description of the circuit design will be provided in the following text, with the description instead primarily covering major functional aspects of the respective arrangement.

FIG. 1 shows a DC-AC inverter arrangement 10, in which a buck converter 11 and a downstream B4 bridge 12 are provided in order to convert an input-side DC voltage u_1 to an output-side AC voltage u_2. As in all of the embodiments illustrated here, the bridge circuit comprises four switching devices S1 to S4 which, specifically, may be in the form of MOSFETs or IGBTs with a low R_{ds,on}. The direct-current controller component 11 in all of the embodiments has an input-side capacitor C_ZK and an output capacitor, which is referred to as C_TSS in FIG. 1 and FIG. 2, as well as a circuit inductance (which is referred to as L_TSS) in FIGS. 1 and 2).

First of all, the input voltage Ui is buffered in the buffer capacitor C_K. This voltage is then stepped down by the buck converter 11 to a voltage U_{TSS}, which can be regulated, where U₁>U_{TSS}>0.

The time profile of the voltage U_{TSS} is defined as a magnitude function of the output voltage u₂(t):

u_{TSS}(t)=|u₂(t)|.

The H-bridge, which is connected to the output of the buck converter, operates as a polarity changer, such that

$${u}_{2} ( t ) = {u}_{TSS} ( t ) * {c}_{H - bridge} with {c}_{H - bridge} = \{ \begin{matrix}1 \\ - 1\end{matrix} = State of polarity changer$$

The circuit from FIG. 1 can be upgraded by designing the buck converter to have a feedback capability. The described topology then also allows power to be taken from the connected power supply system (voltage U₂) and to be stored in the intermediate circuit. A modified inverter arrangement 20 such as this with a buck converter 21 and a B4 bridge 22 is illustrated in FIG. 2. This has a reactive-power capability because of the provision of a second switching device S2_{TSS} in the buck converter and, furthermore, has a higher control margin, which is required in order to make it possible to discharge the filter capacitor C₂ in the buck converter, when the power supply system currents are low.

The topology can additionally be extended by widening the usable input voltage range. In the embodiments shown in FIGS. 1 and 2,

U₁>=U_{TSS}=>U₁>Û₂.

The buck converter used for the first and second embodiments can be combined with a boost converter, as shown in FIG. 3. Accordingly, FIG. 3 shows an inverter arrangement 30 with a boost/buck converter 31 and a B4 bridge 32, with boost converter components S2_HSS and D1_HSS being connected on the output side of the buck converter components S1_TSS and D2_TSS, with joint use of an inductance L_HTSS. In this case, the output capacitor is referred to as C_HTSS.

The boost converter makes it possible to set an output voltage whose instantaneous value may be even higher than the voltage at the intermediate circuit.

Therefore,

$$0 < \frac{{\hat{U}}_{2}}{{U}_{1}} < ∞ ,$$

that is to say it is freely variable.

The joint use of the inductance L_HTSS by the two direct-current components increases the efficiency of the circuit, and at the same time saves components.

As a modification of the circuit arrangement from FIG. 3 with a reactive-power capability, FIG. 4 shows an inverter arrangement 40 with a boost/buck converter 41 with a feedback capability, and with a B4 bridge 42. In comparison to the embodiment shown in FIG. 3, the respective diode is replaced by a respective switching device S2_TSS or S1_HSS both in buck converter section and in the boost converter section.

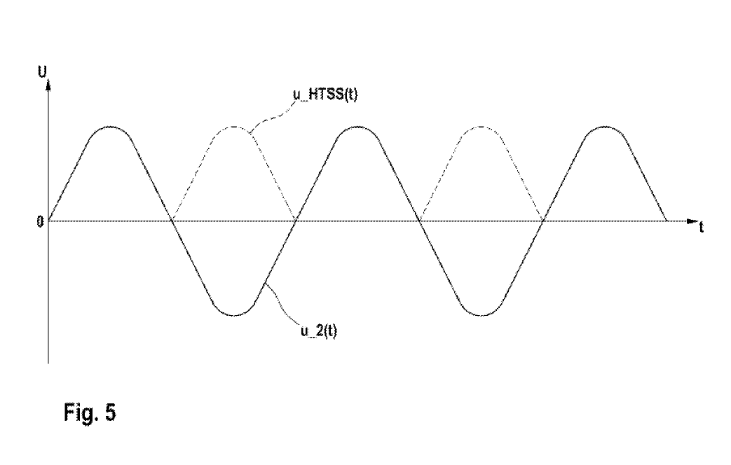

FIG. 5 shows an illustration, in the form of a graph, of the voltage profiles of the output voltage u_HTSS(t) on the boost/buck converter and the output voltage u_2(t) of the inverter arrangement, showing that the direct-current component in the respective circuits provides sine-wave shaping for the input-side DC voltage, while the downstream H bridge or B4 bridge now acts only as a polarity changer.

1. A DC-AC inverter arrangement, comprising:
a semiconductor bridge circuit, and
a direct-current controller configured to produce half-cycles of an output-side AC voltage,
wherein the bridge circuit is connected downstream from the direct-current controller and is configured to act as a polarity changer on the half-cycles.

2. The DC-AC inverter arrangement as claimed in claim 1, wherein the direct-current controller includes a buck converter.

3. The DC-AC inverter arrangement as claimed in claim 1, wherein the direct-current controller includes a combination of a buck converter and a boost converter, or a boost/buck converter with a common inductance.

4. The DC-AC inverter arrangement as claimed in claim 1, wherein the direct-current controller is configured as a four-quadrant controller with a feedback capability, and the inverter arrangement is configured with a reactive-power capability.

5. The DC-AC inverter arrangement as claimed in claim 1, wherein the components of the semiconductor bridge circuit are configured to minimize line losses, while secondarily taking account of switching losses.

6. The DC-AC inverter arrangement as claimed in claim 5, wherein switching devices in the bridge circuit include MOSFETs or IGBTs with a low R_{ds,on} value.

7. The DC-AC inverter arrangement as claimed in claim 1, further comprising a semiconductor diode configured to operate switching devices in the semiconductor bridge circuit in the switched-on state in the reverse conductance mode as well.

8. The DC-AC inverter arrangement as claimed in claim 1, wherein the semiconductor bridge circuit is configured as an H-bridge for a single-phase output.

9. A photovoltaic installation, comprising:
an AC or polyphase power supply system; and
a plurality of solar cell modules, having a connection for feeding electrical energy produced by the solar cell modules to the AC or polyphase power supply system, and having a DC-AC inverter arrangement,
wherein the DC-AC inverter arrangement includes a semiconductor bridge circuit, and a direct-current controller configured to produce half-cycles of an output-side AC voltage, and
wherein the bridge circuit is connected downstream from the direct-current controller and is configured to act as a polarity changer on the half-cycles.

10. An AC-DC inverter arrangement with a feedback capability and having a semiconductor bridge circuit, wherein the semiconductor bridge circuit produces half-cycles of the same polarity from the input-side AC voltage, and further having a direct-current controller that is connected downstream from it in order to produce a smooth DC voltage from the half-cycles of the same polarity.

11. A DC-AC inverter arrangement as claimed in claim 1, wherein the DC-AC inverter is a solar cell inverter of a photovoltaic installation.

12. A DC-AC inverter arrangement as claimed in claim 10, wherein the direct-current controller includes a buck converter.

13. A DC-AC inverter arrangement as claimed in claim 10, wherein the direct-current controller includes a combination of a buck converter and a boost converter.

14. A DC-AC inverter arrangement as claimed in claim 10, wherein the direct-current controller includes a boost/buck converter.
